(19) United States
(12) Patent Application Publication
(10) Pub. No.: US 2008/0254437 A1
(43) Pub. Date: Oct. 16, 2008

(54) Global Computer Network Tutoring System

(76) Inventors: Neil T Heffernan, Worcester, MA (US); Kenneth R. Koedinger, Pittsburg, PA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/989,791

(22) PCT Filed: Jul. 13, 2006
(86) PCT No.: PCT/US2006/027211

§ 371 Date: Jun. 19, 2008

Related U.S. Application Data
(60) Provisional application No. 60/699,625, filed on Jul. 15, 2005.

(51) Int. Cl. G09B 7/08

(52) U.S. Cl. 434/362

(57) ABSTRACT

A global computer network method and apparatus for creating and deploying many types of intelligent tutoring systems across many different platforms is disclosed. A run time engine supports state graph pseudo tutors and JESS model tracing cognitive tutors, in both a client and server context. An Assistment Builder enables development, testing and deployment of the pseudo tutors, generally the tutorials formed of teacher composed problems. The system simplifies the process of tutorial construction to allow educator users with little or no ITS experience to develop content of problems and teaching strategies (i.e., format of problems including hints, messages and sequencing of related problems). The system provides a Web these tutorials. A reporting component is Web based and allows for live database reporting to teachers, showing how their students are performing. Automated analysis and reporting of experimental tutorials developed by teachers is included.

### RELATED APPLICATION

This application claims the benefit of U.S. Provisional Application No. 60/699,625, filed on Jul. 15, 2005. The entire teachings of the above application are incorporated herein by reference.

### GOVERNMENT SUPPORT

The invention was supported, in whole or in part, by grant No. R305K03140 from the Effective Mathematics Education Research program; grant No. N00014-03-1-0221 from the Office of Naval Research; and grant No. REC -0448319, National Science Foundation Career award. The Government has certain rights in the invention.

### BACKGROUND OF THE INVENTION

Tutoring systems are helpful in providing instruction to students. Computer automated and in particular intelligent tutoring systems (ITS) are however very complex and costly to construct. The term Intelligent Tutoring Systems covers a wide range of possible computer-based tutors, from cognitive model tracing tutors (Anderson, J. R., & Pelletier, R., “A development system for model-tracing tutors,” In Proceedings of the International Conference of the Learning Sciences, 1-8, 1991), to constraint-based tutors (Mitrovic, A., & Ohlsson, S., “Evaluation of a Constraint-Based Tutor for a Database Language”, Int. J. on Artificial Intelligence in Education 10 (3-4), pp. 238-256, 1999), to pseudo-tutors. Pseudo-tutors are simplified cognitive models based on state graphs. The state graphs of pseudo-tutors are finite graphs with each node representing a state of the interface, and each arc representing an action made by a student. Student actions trigger transitions in the graph, and the current state of the problem is represented by the graph. Pseudo-tutors are behaviorally equivalent to rule-based tutors.

An ITS may typically be formed of several pseudo tutors. Each pseudo tutor is limited to solving a respective problem.

Another example of an ITS is the “Cognitive Tutor” system sold by Carnegie Learning, Inc. (see www.carnegielearning.com) and partially described in U.S. Pat. No. 6,634,887. While this tutoring system performs “intelligent tutoring”, it does not do so in a Web based manner. Nor does this system allow teachers use a web-based tool to author content themselves, or provide Web based reporting.

### SUMMARY OF THE INVENTION

The present invention addresses the disadvantages of and areas lacking in the prior art.

In a preferred embodiment, a computer-based tutoring system of the present invention is generally formed of three parts, namely a run time engine, a tutorial composer referred to as “Builder” and a Web reporting subsystem. The run time engine takes XML files that represent the interface and the behavior of the intelligent tutoring system and renders them in a server-side manner in either Java Web Start mode or into HTML pages.

The “Builder” is a Web service application that allows teachers to compose and add interesting content to problems/test questions (generally tutorials). Other systems might allow a teacher to post test questions and answers online but do not allow an educator to create scaffolding questions contingent upon whether a student gets one or more items wrong. In addition to authoring scaffolding questions, teachers can create bug messages and hint messages in the present invention. Thus the builder enables teachers to form teaching strategies. Further, various media may be employed in the composed problems (tutorials).

For each student, the runtime engine interactively displays the teacher composed problems to the student according to a curriculum and the teaching strategies. The curriculum selects the problems. The teaching strategies enable any combination of teacher authored explanations, hints, messages and scaffolding of the problems to be displayed in response to student interaction/action (responses).

The Web based reporting subsystem allows for live database reporting to teachers in their classrooms, showing how their students are doing. A logger unit for logging student activity with or use of the invention system and a data store for storing indications of logged student activity supports the reporting subsystem.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1a is a block diagram of an embodiment of the present invention, generally showing the runtime engine, assistment builder and reporter portions thereof.

FIG. 1b (formed of FIGS. 1B-1 and 1B-11) is a schematic view of a runtime engine in embodiments of the present invention.

FIGS. 1c and 1d are example reports generated by embodiments of the present invention.

FIG. 2 is a network architecture and event model diagram of embodiments of the present invention.

FIG. 3 is a schematic illustration of a pseudo tutor employed in one embodiment.

FIG. 4 is a schematic illustration of the teacher-user interface for creating questions including scaffolding in the assistment builder portion of the present invention.

FIG. 5 is a schematic illustration of a transfer model view in the teacher-user interface for correlating created questions to targeted skills in the assistment builder.

FIGS. 6a-6c are schematic and block diagrams of a computer network and network architecture in which embodiments of the present invention operate.

### DETAILED DESCRIPTION OF THE INVENTION

The following describes a preferred embodiment of the present invention.

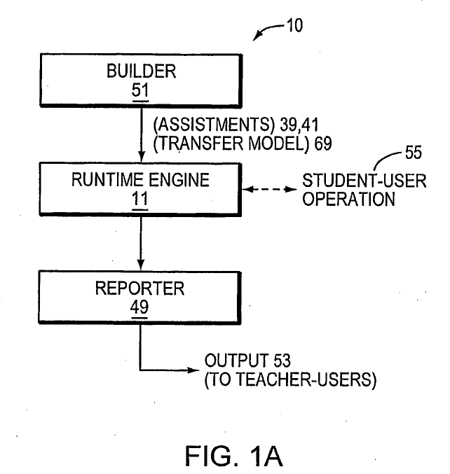

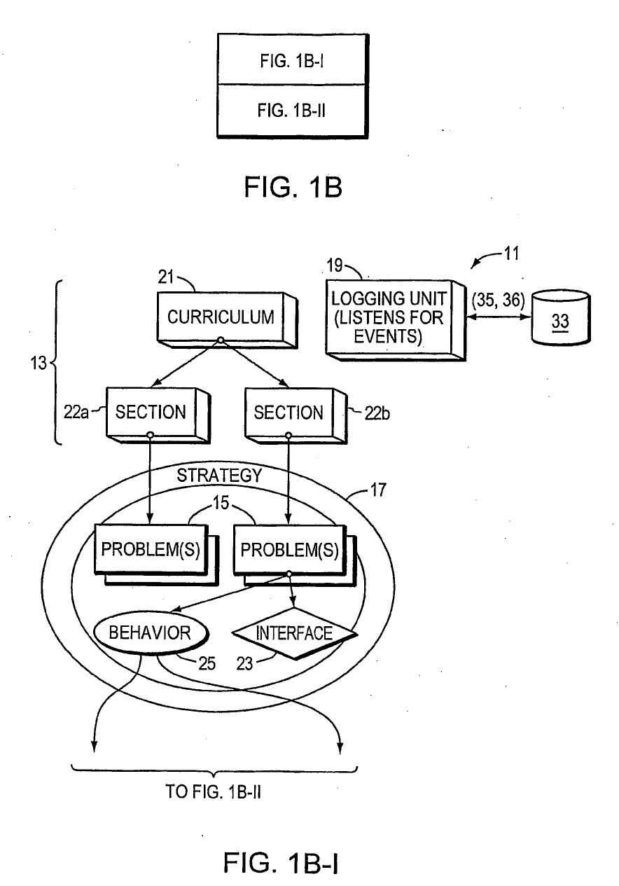

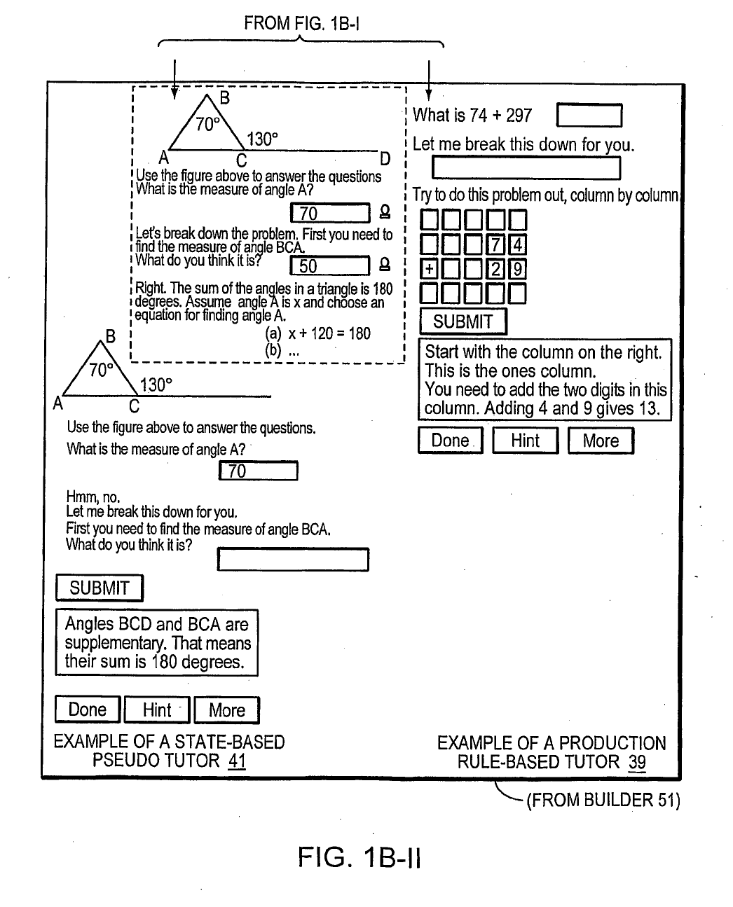

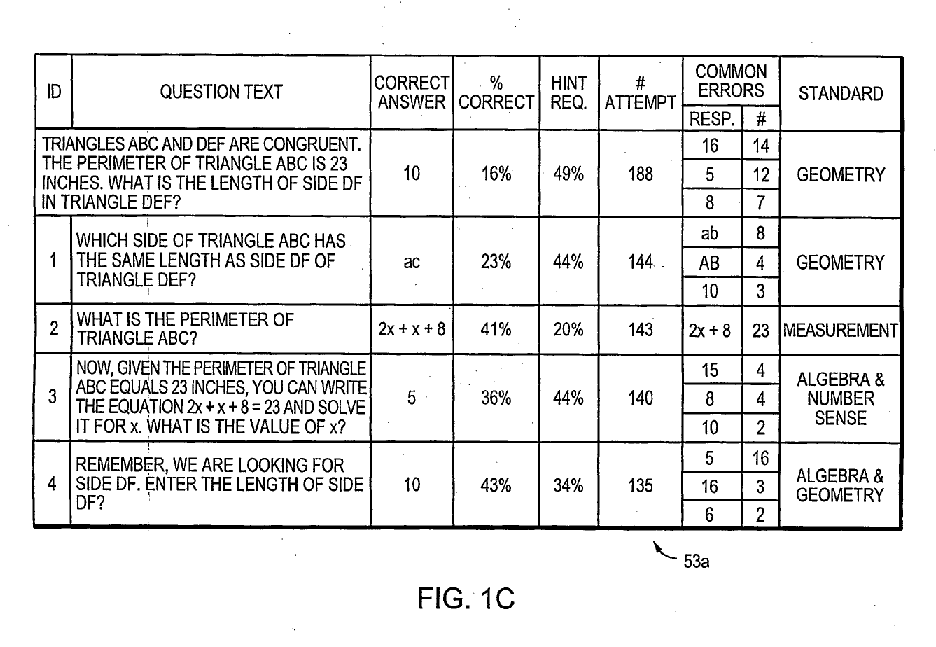

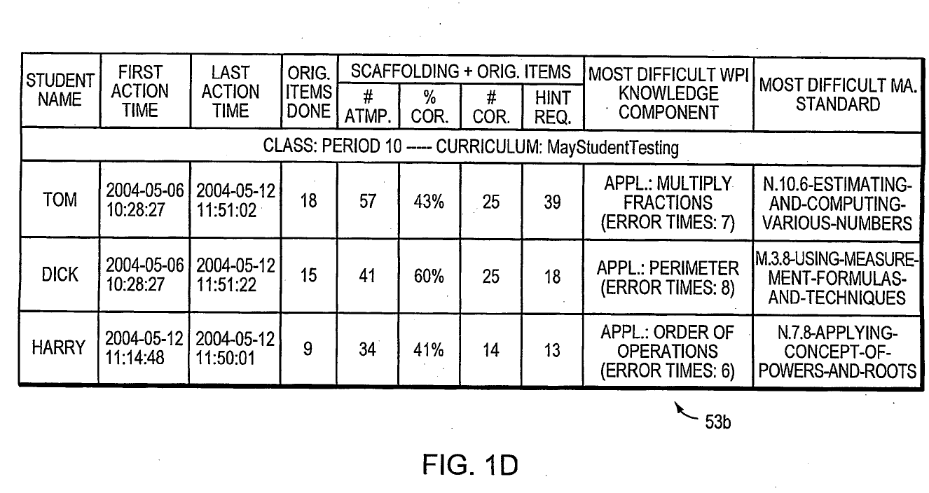

FIGS. 1a-1d provide an overview of embodiments of the present invention 10. Generally embodiments of invention system 10 include a builder member (tutorial composer or authoring tool) 51, a runtime engine 11 and a reporter subsystem 49. As will be further detailed below, the builder member 51 is a computer tool that enables teachers to create specific pseudo-tutors 41 or assistments 39. Preferably the tool 51 has a web based teacher-user interface and is usable by those with no programming experience and no ITS background. The system 10 representation of content provides a base for which one can rapidly create specific pseudo tutors 39, 41.

A secondary purpose of the Assistment Builder 51 is to aid the construction of a Transfer Model 69. A Transfer Model 69 is a cognitive model construct divorced from specific tutors. The Transfer Model 69 is a directed graph of knowledge components representing specific concepts that a student could learn. These knowledge components are then associated with a specific tutor (or even sub-question within that tutor) so that the tutor is associated with a number of knowledge component arcs associated with it. This allows the system 10 to maintain a complex cognitive model of the student without necessarily involving a production rule system. It also allows analysis of student performance in the context of the Transfer Model 69, resulting in knowledge tracing and other useful methods. The simplest way to “mark” tutors 39, 41 in a Transfer Model 69 is to associate the tutors 39, 41 (or their sub-questions) with knowledge components when the tutors 39, 41 are created.

Upon content creation, the runtime engine 11 deploys tutors 39, 41 across a global computer network (i.e., the Web) and if errors are found within a tutor, bug-fixing or correction is quick and simple through builder 51. Further the runtime engine 11 has a student-user 55 interface for operation of and interaction with the teacher created tutors 39, 41. The runtime engine 11 also logs data (e.g., student answers) from student sessions. A reporter subsystem 49 utilizes the stored data of runtime engine 11 to generate student specific, classwide, subject specific and other reports 53 for teachers, administrators and the like. Example reports 53a, b are shown in FIGS. 1c and 1d respectively. Common reporter techniques and methods known in the art are employed.

The architecture and run time engine of a preferred embodiment is referred to as the extensible Tutor Architecture (XTA) 11 illustrated in FIG. 1b (consisting of FIGS. 1B-1 and 1B-11). This framework controls the interface and behaviors of the invention intelligent tutoring system 10 via a collection of modular units. The modular units conceptually include a curriculum unit 13, a problem unit 15, a strategy unit 17, and a logging unit 19. Each conceptual unit has an abstract and extensible implementation allowing for evolving tutor types and content delivery methods.

FIG. 1b shows the relationships between the different units 13, 15, 17, and 19 and their hierarchy. Within each unit, the XTA 11 has been designed to be highly flexible in anticipation of future tutoring methods and interface layers. This is accomplished through encapsulation, abstraction, and clearly defined responsibilities for each component.

### Curriculum Unit

The curriculum unit 13 is conceptually subdivided into two main pieces: the curriculum 21 itself, and sections 22. The curriculum 21 is composed of one or more sections 22a,b, with each section 22 containing problems 15 or other sections 22. This recursive structure allows for a rich hierarchy of different types of sections 22 and problems 15.

Preferably, a given curriculum 21 selects problems 15 to work on from its internal hierarchy of sections 22. In turn, sections 22 select problems 15 from a list, either randomly or in a set order, or arrange problems 15 into groups and conduct a randomized controlled experiment.

Progress within a particular curriculum 21, and the sections 22 of which it is composed, are stored in a progress file—an XML meta-data store that indexes into the curriculum 21 and the current problem 15 (one progress file per student per curriculum). A student's progress is conceptually a stack of indexes into a particular curriculum 21 and hierarchy of sections 22.

The section component 22 is an abstraction for a particular listing of problems 15. The problems 15 may be of any type—pseudo tutors, rule-based tutors, etc. This abstraction enables extension and implementation of various section types, and allows for future expansion of the curriculum unit 13. Section 22 types include “Linear” (problems or sub-sections are presented in linear order), “Random” (problems or sub-sections are presented in a pseudo-random order), and “Experiment” (a single problem or sub-section is selected pseudo-randomly from a list, the others are ignored). In other embodiments, section types include a “Directed” section, where problem selection is directed by the student's knowledge model.

### Problem Unit

The problem unit 15 represents a problem to be tutored, including questions, answers, and relevant knowledge-components required to solve the problem. Each problem 15 is composed of an interface 23 (platform independent abstract definition of the user interface) and a behavior 25 (e.g., pseudo-tutors 41 contain a state machine, rule-based tutors 39 contain production rules, and so on.) For instance, in a preferred embodiment, pseudo-tutors 41 are a hierarchy of questions connected by correct and incorrect answers, along with hint messages and other feedback.

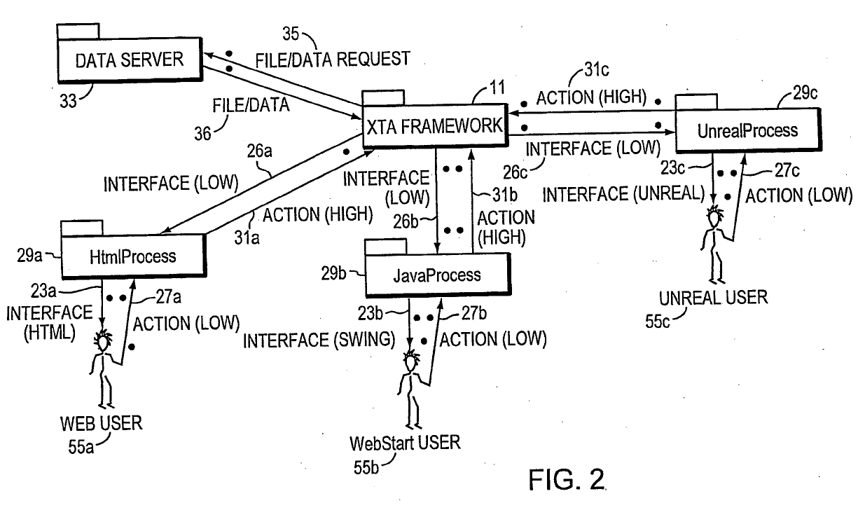

The interface 23 definition is interpreted by the runtime engine 11 and displayed for viewing and interaction to the user. This display follows a two-step process, allowing for easy customization of platform and interface specification The interface 23 definition consists of “high-level” interface elements (“widgets”) 29 in FIG. 2, which can have complex behavior (multimedia, spell-checking text fields, algebra parsing text fields and the like). These “high-level” widgets 29 have a representation in the runtime composed of “low-level” widgets 26. “Low-level” widgets 26 are widgets common to many possible platforms of interface 23, and include text labels, text fields, images, radio buttons, etc. These “low-level” widgets 26 are then consumed by an interface 23 display application. Such applications consume “low level” widget XML, and produce an interface on a specific platform. One embodiment is implemented as a Java Swing interface 23b display application, and a HTML interface 23a display application that runs through a J2EE container. Because in some embodiments there is a requirement to support HTML thin clients, the interface widget set 26, 29 is somewhat limited compared to another widget kit, such as Java Swing. However, the event model (described below) and relationship of “high-level” 29 to “low-level” 26 widgets allow a significant degree of interface customizability even with the limitations of HTML. Other technologies, such as JavaScript and streaming video may be used to supplement the interface 23. Other interface display applications are suitable.

The behaviors 25 (FIG. 1B-1) for each problem 15 define results of actions on the interface 23. An action might consist of pushing a button or selecting a radio button. Examples of behavior 23 definitions are state graphs, cognitive model tracing, or constraint tutoring, defining the interaction that a specific interface 23 definition possesses. Full cognitive model behaviors (e.g. using JESS (Java Expert System Shell) production rules) and other types of cognitive models supportable by the present invention are outlined in part in Jarvis, et al. (Jarvis, M., Nuzzo-Jones, G. & Heffeman. N. T., “Applying Machine Learning Techniques to Rule Generation in Intelligent Tutoring Systems,” Proceedings of 7^{th} Annual Intelligent Tutoring Systems Conference, Maceio, Brazil. Pages 541-553, 2004). The abstraction of behaviors allows for easy extension of both their functionality and by association their underlying XML definition.

Upon student-user interaction, a two-tiered event model (shown in FIG. 2) is used to respond to that interaction. These tiers correspond to the two levels of widgets described above, and thus there are “high-level” actions 31 and “low level” actions 27. When the student-user 55a, b, c creates an event in the interface 23a, b, c, it is encoded as a “low-level” action 27a, b, c and passed to the “high-level” interface widget 29a, b, c. The “high-level” interface widget 29a, b, c may (or may not) decide that the “low-level” action 27 is valid and encode it as a “high-level” action 31a, b, c. An example of this is comparing an algebra text field (scripted with algebraic equality rules) with a normal text field by initiating two “low-level” actions 27 such as entering “3+3” and “6” in each one. The algebra text field would consider these to be the same “high-level” action 31, whereas a generic text field would consider them to be different “high-level” actions 31. “High-level” actions 31 are processed by the interpreted behavior 25 and the interface 23 is updated depending on the behavior's response to that action. The advantage of “high-level” actions 31 is that they allow an interface widget 29 or content developer to think in actions relevant to the widget, and avoid dealing with a large number of trivial events.

### Strategy Unit

Returning to FIG. 1b, the strategy unit 17 allows for high-level control over problems 15 and provides flow control between problems 15. The strategy unit 17 comprises tutor strategies and a control structure of the runtime called the agenda. Strategies 17 operate over problems 15 and within behaviors 25 to modify the agenda. Different tutor 39, 41 strategies can make a single problem 15 behave in different fashions. For instance, a scaffolding tutor strategy arranges a number of problems 15 in a tree structure, or scaffold. When the student answers the root problem 15 incorrectly, a sequence of other problems 15 associated with that incorrect answer is queued for presentation to the student. These scaffolding problems 15 can continue to branch as a the roots of their own tree. It is important to note that each problem 15 is itself a self-contained behavior 25, and may be an entire state graph/pseudo-tutor, or a full cognitive tutor.

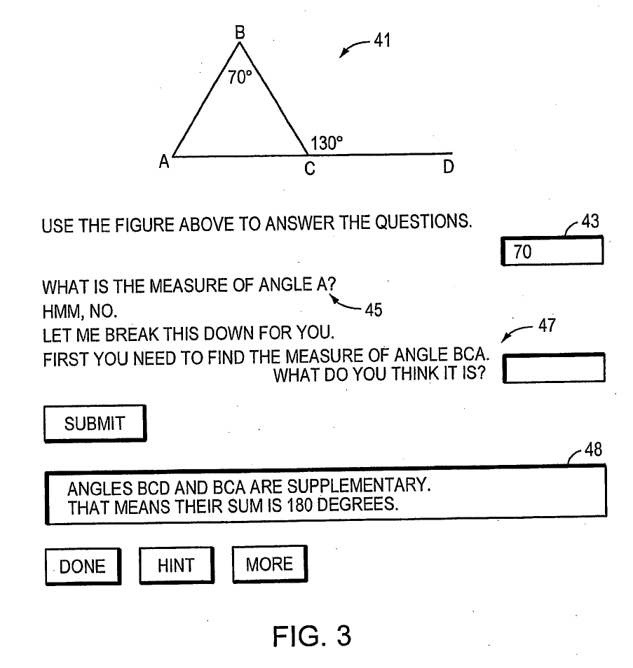

FIG. 3 is an example scaffolding pseudo tutor 41. The student user's answer input into field/box 43 to the first question 45 (root problem) is incorrect. So the tutor 41 displays a sequence of related problems 15 (illustrated at 47) used toward solving the root problem 45.

Others types of tutor strategies include message strategies, explain strategies, and forced scaffolding strategies. The message strategy displays a sequence of messages, such as hints or other feedback or instruction. The explain strategy displays an explanation of the problem 15, rather than the problem 15 itself. This type of tutoring strategy would be used when it is already assumed that the student knew how to solve the problem. The forced scaffolding strategy forces the student into a particular scaffolding branch, displaying but skipping over the root problem 15. Other tutor strategies are suitable.

The left hand portion of FIG. 1B-11 shows problem 15 employing scaffolding pseudo tutor 41 in a state-based implementation. System 11 displays the scaffolded portions and hint questions or messages in response to student-user input (response) and interaction. Some embodiments display incorrect responses in red and hints in green, or other suitable color schemes. The illustrated example problem 15 is shown rendered in HTML (left portion) and Swing (overlaid center portion). An example production rule based tutor 39 on the right hand side of FIG. 1B-11 illustrates a problem 15 that uses JESS Production Rules to implement an addition tutor. In the shown example tutor 39, hint messages and buggy messages are dynamically generated based upon model-tracing of the student's cognitive model.

The concept of a tutor strategy is implemented in an abstract fashion, to allow for easy extension of the implementation in other embodiments. Such other tutor strategies could include dynamic behavior based on knowledge tracing of the student log data. This would allow for continually evolving content selection, without a predetermined sequence of problems.

The dynamic content selection is enabled by the agenda. The agenda is a collection of problems 15 arranged in a tree, which have been completed or have been queued up for presentation. The contents of the agenda are operated upon by the various tutor strategies, selecting new problems 15 from sections 22 (possibly within sections) within a curriculum 21 to append and choosing the next problem 15 to travel to.

### Logging Unit

With reference to FIG. 1b, the final conceptual unit of the XTA 11 is the logging unit 19. Logging unit 19 is coupled to a relational database 33 in a manner supporting file data requests 35 and transmissions 36 as further illustrated in the event model of FIG. 2. The benefits of logging in the domain of ITS has been acknowledged, significantly easing data mining efforts, analysis, and reporting. Additionally, judicious logging can record the data required to replay or rerun a student user's session.

The logging unit 19 receives detailed information from all the other units relating to user actions and component interactions. These messages include notification of events such as starting a new curriculum 21, starting a new problem 15, a student answering a question, evaluation of the student's answer, and many other user-level and framework-level events.

Capturing these events gives an assortment of data to analyze for a variety of needs. User action data captured allows invention system 10 to examine usage-patterns, including detection of system gaming (superficially going through tutoring-content without actually trying to learn). This data also enables system 10 to quickly build reports 53a, b (FIGS. 1c and 1d) for teachers on their students, as well as to give a complete trace of student work. This trace allows an end-user teacher to replay a student-user's 55 session, which could be useful for quickly spotting fundamental misunderstandings on the part of the student-user, as well as debugging the content and the system itself (by attempting to duplicate errors).

The logging unit components are appropriately networked to leverage the benefits of distributing the invention framework over a network and across machines. This provides scalability.

### System Architecture

The XTA 11 provides a number of levels of scalability. To allow for performance scalability, the runtime engine 11 has a low memory footprint. It is anticipated, based on simple unit testing, that thousands of copies of the XTA 11 could run on a single machine. More importantly, the individual units described above are separated by network connections (see for example, 23, 26, 27, 31, 35 and 36 in FIG. 2). This allows individual portions of the XTA to be deployed on different computers. Thus, in a server context, additional capacity can be added without software modification and scalability is assured.

The runtime engine 11 can also transform with little modification into a client application or a server application instantiated over a web server or other network software launch, such as Java WebStart. Both types of applications allow for pluggable client interfaces due to a simple interface and event model, as described in the interface unit 23. A client side application contains all the network components described above in FIG. 2 as well as content files required for tutoring, and has the capacity to contact a remote logging unit 19 to record student actions. Running the XTA 11 in a server situation results in a thin client for the user (e.g. either HTML or Java Webstart), which operates with the interface 23 and event model of the server. Thus, the server runs an instance of the XTA 11 for every concurrent user, illustrating the need for a small memory footprint. The XTA instances on the server contact a centralized logging unit 19 and thus allow for generated reports available through a similar server.

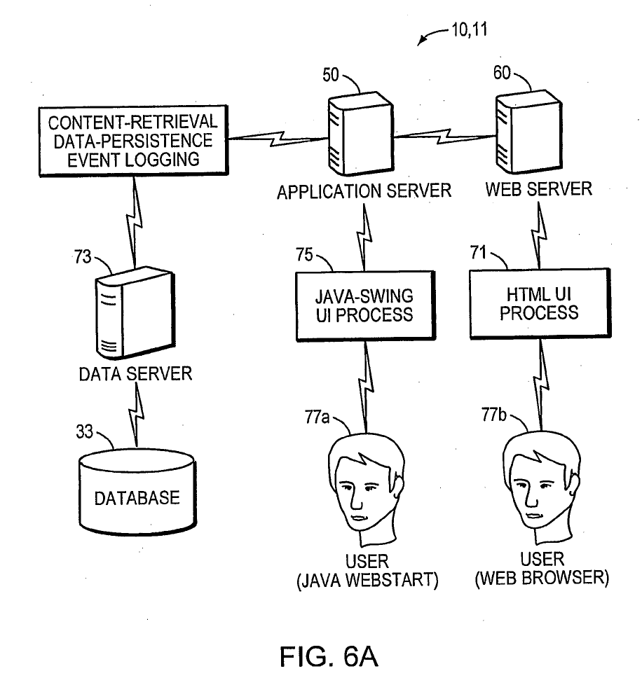

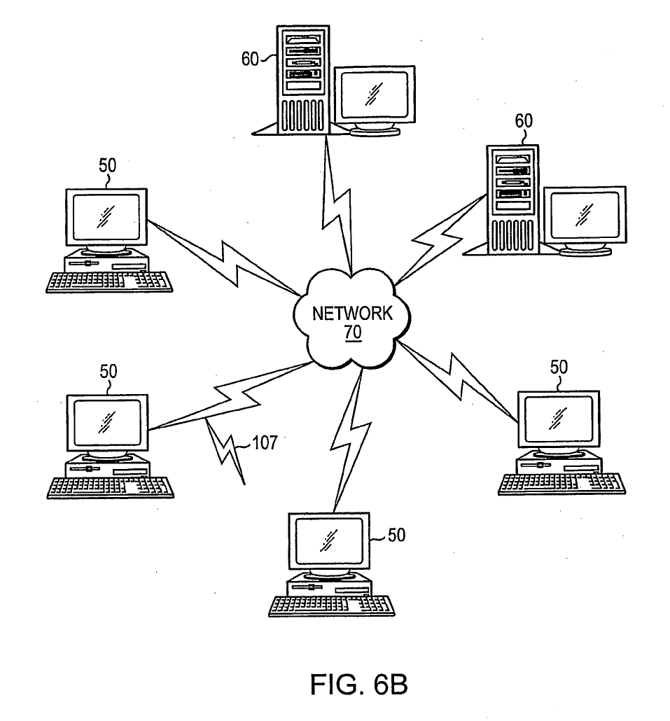

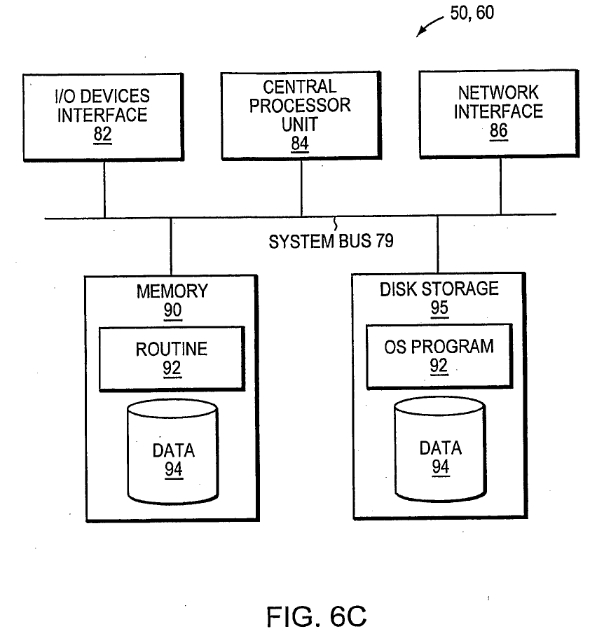

In a preferred embodiment, the network architecture is configured as shown in FIG. 6a. The application server 50, web server 60 and data server 73 can run on one machine or separate machines. Additional web servers 60 can be added for load balancing. The data server 73 handles database requests and data persistence (i.e., file system or database 33 data storage and retrieval). The data server 73 is also responsive to user level and framework level events and logs the same in database 33. This effectively implements logging unit 19 discussed above. The database system 33 is any database with a JDBC driver.

Users on different platforms may use the same invention system 10 simultaneously. Illustrated is one user 77a obtaining access through a Java Webstart network software launch of the invention program runtime (engine) 11, and another user 77b obtaining access through a web browser supported by web server 60. The HTML user interface process 71 converts abstract user interface into HTML widgets as explained in FIG. 2 above. The Java Swing user interface process 75 converts the same abstract user interface into Java Swing widgets as previously detailed in FIG. 2. The user interactions represented as respective user interface widgets cause various content retrieval and storage events at application server 50, web server 60 and data server 73. Illustrated users 77 include teachers and students. Other configurations are suitable.

In preferred embodiments, not only is runtime engine 11 configured for global network implementation as in FIG. 6a, but tutorial builder 51 and reporter 49 of FIG. 1a are also configured for web application or other global computer network operation. Generally, such a computer network environment for deploying embodiments of the present invention is further illustrated in FIGS. 6b and 6c.

Referring to FIGS. 6b and 6c, client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 6c is a diagram of the internal structure of a computer (e.g., client processor/device 50 or server computers 60) in the computer system of FIG. 6b. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6b). Memory 90 provides volatile storage for computer software instructions 92 and data 94 used to implement an embodiment of the present invention (e.g., assistment builder 51, runtime engine 11, reporter 49 and supporting data elements and models 39, 41, 69, 33 detailed above and below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

The Builder Web service portion 51 of the preferred embodiment of the present invention is detailed next. The assistment Builder 51 is a Web based tutor creation tool in the preferred embodiment. Using the Builder 51, teacher-users select items to put into experiments and build randomized tutorials. The teacher-users then assign these experiments to classes and schedule when to be automatically notified of analysis results. For example, a teacher investigated whether students would learn better if asked to set up proportions. The author teacher built two different Assistments 39, 41 that differed only by one extra scaffold. The author teacher made a second version of each Assistment by changing the “cover story”. Finally the author teacher selected two items to posttest for “far transfer”. The invention system 10 automatically tracks student usage/performance and performs an analysis. The results of the analysis show the “setup ratio” condition to have better learning within the condition as well as better learning on the posttest/transfer items. The system 10 then automatically reports to the teacher user the analysis results. In a preferred embodiment, e-mail communications are used by the system 10 to automatically transmit and report the analysis results to the teacher.

More generally the Web based tutor creation tool 51 of the present invention allows “Assistments” to be created that are behaviorally equivalent to rule based cognitive tutors but are not general. While the present invention architecture allows both rule based and state based tutors 39, 41, the Builder 51 creates a tutor 39, 41 for a single item.

As previously mentioned, a pseudo-tutor is a simplified cognitive model based on a state graph. State graphs are finite graphs with each arc representing a student action, and each node representing a state of the problem interface. Student actions trigger transitions in the graph, and the current state of the problem is stored by the graph. Pseudo-tutors have nearly identical behavior to a rule-based tutor, but suffer from having no ability to generalize to different problems. This pseudo-tutor approach allows for predicted behaviors and provides feedback based on those behaviors. Applicants also combine the state graph with a conceptually broader branching structure referred to as scaffolding. Scaffolding provides sub-problems to the initial question, often designed to address specific concepts within the initial question. Both initial and scaffold questions can branch to different scaffolding questions depending on a student's actions. This allows for a higher level of predicted actions to be handled.

The basic structure of an Assistment (generally 39) is a top-level question that is able to branch to scaffolding questions based on student input. The Assistment Builder 51 interface uses only a subset of the full content XML representation, with the goal of producing simple pseudo-tutors 39, 41. Instead of allowing arbitrary construction of question interfaces, there are preferably five widget choices available to a content creator. These are radio-buttons, pull-down menus, checkboxes, text-fields, and algebra text fields that automatically evaluate mathematical expressions. The state graphs for each question are limited to two possible states. An arc occurs between the two states when the student end-user 55 answers a question properly. The student remains in the initial state until the question is answered properly or skipped programmatically.

The scaffolding questions mentioned above are queued as soon as a student-user 55 gets the top-level question incorrect, or requests help in the form of a hint (for either event, the top-level question is skipped). Upon successfully completing the displayed scaffolding question, the next is displayed until the queue is empty. Once the queue is empty, the problem is considered complete. This type of linear Assistment is easily made with invention Builder member 51 by first creating the main item and then the subsequent scaffolding questions. When building an Assistment 39, 41, a teacher-user may also add questions that will appear when a specific incorrect answer is received. This allows branches to be built that tutor along a “line of reasoning” in a problem, which adds more generality than a simple linear Assistment. Many Assistment authors also use text feedback on certain incorrect answers. These feedback messages are called “bug messages”. Bug messages address the specific error made, and match common or expected mistakes.

Content creators can also use the Assistment Builder 51 to add hint messages to problems, providing the student with hints attached to a specific scaffolding question. This combination of hints, buggy messages, and branched scaffolding questions allows even the simple state diagrams described above to assume a useful complexity. Assistments 39, 41 constructed with the Assistment Builder 51 can provide a tree of scaffolding questions branched from a main question. Each question comprises a customized interface, hint messages and bug messages, along with possible further branches.

### Web Deployment

As mentioned above, one embodiment of the Assistment Builder 51 is constructed as a web application for accessibility and ease of use purposes. With Builder 51, a teacher or content creator creates, tests, and deploys an Assistment 39, 41 without installing any additional software. The teacher-user designs and tests his Assistment 39, 41 and then invention system 10 instantly deploys it. If further changes or editing are needed, the Assistment 39, 41 is loaded into the builder 51, modified, and then redeployed across all the curriculums 21 that make use of the tutor 39, 41. By making the Assistment Builder 51 available over the web, if a new feature is added teacher-users do not need to update any software. They reap the benefits of any changes made to the system 10 as soon as they log on. By storing created Assistments 39, 41 locally on servers, teacher end-users are allowed to easily create a curriculum 21 and assign it to a class for use by students.

In preferred embodiments, when a teacher-user first begins a session with the Assistment Builder 51, he is greeted by a standard blank skeleton question. The initial blank skeleton question is used to create the root question. The teacher enters the question text, images, answers, and hint messages to complete the root question. After these steps the appropriate scaffolding is added. The question layout is separated into several views: the Main View, All Answer View, Correct Answer View, Incorrect Answer View, Hints View, and Transfer Model View. Together these views allow a teacher-user to highly customize a subject question and its subsequent scaffolding.

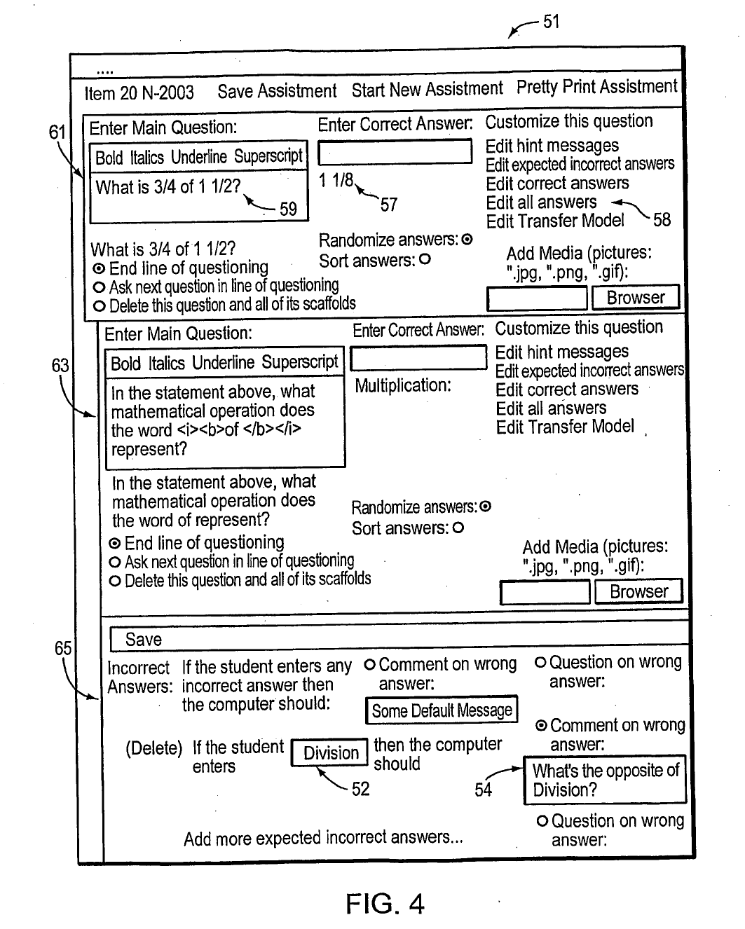

Initially the teacher-user is presented with the Main View 61 (see FIG. 4). In this view question text 59, correct answers 57, and images can be added to the subject question. Additionally the teacher-user can add new scaffolding off the current question 59, and specify if he would like the answers to be in a sorted or random order. The Main View 61 is preferably designed to gather the absolute minimum information needed to generate a question (such as at 45 in FIG. 3).

Upon completion of the items in the Main View 61, the teacher-user then has the option to move to other views in order to further refine the question. Typically the next view to complete is the All Answer View. This can be done by selecting “Edit all answers” 58 from the list of links below Customize this Question from the Main View 61. In the All Answers View, the teacher-user has the option to add additional correct answers as well as expected incorrect answers. The expected incorrect answers serve two purposes. First, they allow a teacher to specify the answers students will most likely expect as the correct answer and provide feedback in the form of a message 48 or scaffolding 47 (FIG. 3). Second, the teacher-user has the option to select the question input type, certain input types present a list of answers for the student to select from, expected incorrect answers are useful here to populate this list; additional tutoring by means of message or scaffold is also possible with these incorrect answers. The illustration of FIG. 4 shows one scaffold 63 generated from the All Answers View.

Once the teacher-user has finished with this view either the Correct Answer View or the Incorrect Answer View 65 (FIG. 4) is the next step. In the Correct Answer View, the teacher-user provides a specific message to be displayed on a correct answer as well as add additional correct answers. From the Incorrect Answer View 65 further information can be provided as to the action that will be taken on a specific incorrect answer 52; new incorrect answers can also be added here. The teacher-user now has the option (at 54) to specify a message to be displayed for an incorrect answer or the option to scaffold similar to that of 63. If the scaffolding option is chosen, Builder 51 displays a new question block indented below the current question of view 65, and so on.

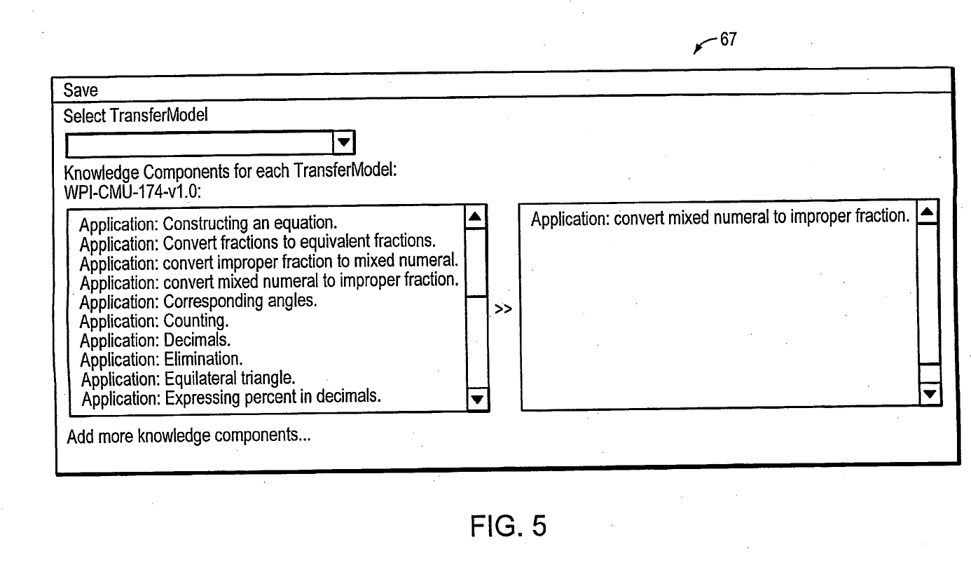

In the Hints View, messages can be created that will be presented to the student when he requests a hint. Hints can include text, an image, or both. Multiple hint messages can be entered; one message will appear per hint request in the order that they are listed by a teacher in this view. The final view is the Transfer Model View 67 (FIG. 5). In this view 67, the teacher-user has the option of specifying one or more skills that are associated with this particular question. These skills are then used to establish learning accomplished on this problem. By tagging items in the various scaffold 63 and question/answer views 61, 65 with skills, a teacher-user effects system 10 to report on which skills students are doing poorly and to track them over time.

As mentioned above there are two methods of providing a scaffolding question 63: either by selecting Ask Next Line of Questioning from the Main View 61 or specifying scaffolding on a specific incorrect answer. In utilizing either of these methods, builder 51 inserts a new skeleton question into the correct position below the current question. Creating a scaffolding question 63 is done in the same manner as the root question. Once a teacher-user is satisfied with the root question and its scaffolding, he provides a name for the question and saves the newly composed Assistment 39, 41. After saving the Assistment 39, 41, the tutor is ready to be used. An Assistment 39, 41 can be modified at any time by loading it into the Assistment Builder 51 and changing its properties as desired.

Other embodiments may utilize a tab system that allows the teacher-user to navigate the different components of a question. The use of tabs allows Builder 51 to present the teacher-user with only the information related to the current view, reducing the confusion that sometimes takes place in current interfaces.

In other embodiments there is a new question type. This question type allows a teacher-user to create a question with multiple inputs of varying type. This embodiment enables the teacher-user to include images and Macromedia Flash™ or similar movies. Aside from allowing multiple answers in a single question, the new question type allows a much more customizable interface for the question. Teacher-users can add, in any order, a text component, a media component, or an answer component. The ability to place a component in any position in the question allows for a more “fill in the blank” feel for the question and provide a more natural layout.

Other embodiments may include an interface for creating more complex types of tutors with richer state graphs, and eventually rule-based tutors. Such embodiments include support for learning rule-based cognitive models from examples. Other options could include a wizard interface for simple scripting support (similar to the scripting wizards in Microsoft Excel™).

### EXAMPLE

The XTA 11 has been deployed as the foundation of the Assistments Project: “Razzab, L. et al., “Blending Assessment and Instructional Assisting, Proceedings of the 12th Conference on Artificial Intelligence in Education, Amsterdam 2005, pp. 555-562. This project provides mathematics tutors to Massachusetts students over the web and provides useful reports to teachers based on student performance and learning. The system has had nearly 1000 total users. These users have resulted in over 1.3 million actions for analysis and student reports. To date, there has been a live concurrency of approximately 50 users from Massachusetts schools. However, during load testing, the system was able to serve over 500 simulated clients from a single J2EE/database server combination. The primary server used in this test was a Pentium™ 4 with 1 gigabyte of RAM running Gentoo Linux. The objective is to support 100,000 students across the state of Massachusetts. One hundred thousand students divided across five school days would be 20,000 users a day. Massachusetts's schools have seven class periods, which would be roughly equivalent to supporting 3,000 users concurrently. This calculation is based on estimations, and it is noted that the example system has not been load tested to this degree.

Tutors that have been deployed include scaffolding state diagram pseudo-tutors 41 with a variety of strategies. In the example system, a small number of JESS cognitive tutors for specialized applications were also deployed. It is noted that the tutors used in the scaling test described above were all pseudo-tutors, and it is estimated that a much smaller number of JESS tutors could be supported.

The Transfer Model used to classify 8^{th} grade mathematics items has 174 knowledge components. Nearly 1000 individual problems have been associated with these 174 knowledge components.

In summary, the launch of the XTA has been successful (available at www.assistments.org). The configuration being used in the Assistments project is a central server as described above, where each student uses a thin HTML client and data is logged centrally. The software has been considered stable for several months, and has been enthusiastically reviewed by public school staff. Since September 2004, the software has been in use at least three days a week over the web by a number of schools across central Massachusetts. This deployment is encouraging, as it demnonstrates the stability and initial scalability of the XTA, and provides significant room to grow.

However, this test of the software was primarily limited to pseudo-tutors, though model-tracing tutors are supported. One of the significant drawbacks of model-tracing tutors in a server context is the large amount of resources they consume. This resource consumption would prohibit scaling to the degree initially desired. A partial solution to this might be the support of constraint-based tutors, which could conceivably take fewer resources. These constraint tutors could take the form of a simple JESS model (not requiring an expensive model trace), or another type of scripting language embedded in the state-graph pseudo-tutors.

Other embodiments of invention system 10 (runtime engine 11) include dynamic curriculum sections, which select the next problem based on the student's performance (calculated from logged information). Similarly, new tutor strategies may alter their behavior based on knowledge tracing of the student log data. Also, new interface display applications are under consideration, using the interface module API. As mentioned, such interfaces may include Unreal Tournament™, Macromedia Flash™, or a Microsoft.NET™ application. The customizable nature of the invention system 10/XTA 11 makes it a valuable tool in the continued evolution of Intelligent Tutoring Systems.

Thus the present invention provides an automated Web based tutoring system 10 in which non-programmers can easily build content in fractions of the amount of time taken in ITS systems of the prior art. The quality of the content in the present invention system has also been shown to lead to statistically significant learning.

While this invention has been particularly shown and described with references to preferred embodiments thereof it will be understood by those skilled in the art that various changes in form and details may be made therein without departing from the scope of the invention encompassed by the appended claims.

In the above discussion, pseudo-tutors 39 are often referred to as Assistments, but the term is not limited to pseudo-tutors. “Assistment” is a hybrid term combining assessment and assisting.

Other computer network configurations and architectures instead of those of FIGS. 6a-c are suitable.

What is claimed is:

1. In a global computer network, a computer system for tutoring a student comprising:
a run time engine formed of an agenda, a curriculum and teaching strategies, the agenda determining what messages, media and problems to display currently to a student user and those scheduled to be displayed, the curriculum selecting problems for use in the agenda, and the teaching strategies for modifying the agenda with at least scaffolding of problems;
a tutorial composer enabling teachers to add content to agendas of the run time engine; and
a reporting component enabling real time reporting of students' work/progress to teachers.

2. A system as claimed in claim 1 wherein the teaching strategies modify the agenda with any combination of explanations, hints, bug messages and scaffolding.

3. A system as claimed in claim 2 wherein scaffolding employs arcing or transitioning from one problem to another problem.

4. A system as claimed in claim 1 wherein the problems implement any of state based behaviors or rule based behaviors.

5. A system as claimed in claim 1 wherein the curriculum (1) selects problems randomly or in a predefined order and/or (2) arranges problems into groups.

6. A system as claimed in claim 1 wherein the reporting component further includes:
a logger for logging student user actions and framework level events; and
a data store coupled to the logger for storing indications of logged student user actions, curriculum, problem information and media.

7. A system as claimed in claim 1 wherein the agenda further includes grade level content including grade level mathematics.

8. In a global computer network, a method for tutoring students comprising the computer implemented steps of:
enabling a teacher to compose problems to display to students and to form teaching strategies with at least scaffolding of problems; and
for each student, interactively displaying the composed problems to the student according to a curriculum and the teaching strategies, the curriculum selecting problems and the teaching strategies enabling any combination of teacher authored explanations, hints, messages and scaffolding of the problems to be displayed in response to student interaction/action.

9. A method as claimed in claim 8 wherein scaffolding employs arcing or transitioning from one problem to another problem.

10. A method as claimed in claim 8 wherein the problems implement any of state based behaviors or rule based behaviors.

11. A method as claimed in claim 8 wherein the curriculum (1) selects problems randomly or in a predefined order and/or (2) arranges problems into groups.

12. A method as claimed in claim 8 wherein the step of enabling teachers to compose problems includes enabling composed problems to include various media.

13. A method as claimed in claim 12 wherein the step of displaying includes determining what messages, problems and media to display currently to a student and which are scheduled to be displayed to the student.

14. A method as claimed in claim 8 wherein the step of displaying is during runtime; and
the method further comprising the automated steps of:
logging student actions and runtime level events, and storing indications of the logged student actions, curriculum and composed problems.

15. A method as claimed in claim 14 further comprising the step of reporting students' progress to teachers using the stored indications, said reporting including real-time reporting to teachers.
